(19) United States
(12) Patent Application Publication
(10) Pub. No.: US 2015/0001292 A1
(43) Pub. Date: Jan. 1, 2015

(54) DEVICE, SYSTEM AND METHOD FOR TRACKING AND RECORDING SHIPMENT OF GOODS

(71) Applicant: Delivery Express, Inc., Renton, WA (US)

(72) Inventor: Dave Hamilton, Bellevue, WA (US)

(21) Appl. No.: 14/305,922

(22) Filed: Jun. 16, 2014

Related U.S. Application Data
(60) Provisional application No. 61/840,280, filed on Jun. 27, 2013.

(51) Int. Cl. G06F 17/30; G06K 19/06; G06K 19/00

(52) U.S. Cl. CPC G06F 17/30; G06K 19/00; G06K 19/06028; G06K 19/06037
USPC 235/380; 235/487

(57) ABSTRACT

An intelligent signature card worn by an individual displays the wearer's name and includes an embedded Quick Response (QR) code or other barcode or information storage element containing personally identifiable information about the wearer. When the individual needs to receive a delivery, she/he displays the card to delivery personnel who use a mobile device to scan the code without touching the card. Further, the consignee need not touch the scanning device or remove rubber gloves (if worn) in order to provide an electronic signature. The consignee's information is collected and saved verifying delivery and completion of a shipment. Similarly, an intelligent delivery card is useable where a delivery location is unattended and an intelligent tracking card is useable to track the goods during shipment.

### PRIORITY CLAIM

This application claims priority to and the benefit of U.S. Provisional Application No. 61/840280, filed on Jun. 27, 2013, and is incorporated by reference herein in its entirety.

### FIELD OF THE INVENTION

The present disclosure is directed generally to the shipment of goods and more specifically to tracking and recording the shipment of goods using intelligent identification cards.

### BACKGROUND OF THE INVENTION

Historically, in the field of transportation and the delivery of goods, consignees (persons designated to receive delivered goods) have used writing implements to sign a paper manifest proving receipt of shipment. Technological advancements have made it possible to collect and convey proof of delivery and/or chain of custody information electronically, also known as electronic signature capture.

In certain environments, such as medical or scientific laboratories, rubber gloves worn by a consignee may hinder her or his ability to produce a signature on an electronic device, such as a cell phone or tablet, for example. The capture of electronic signatures is a challenge in such environments, since most lab personnel are required to wear rubber gloves. The rubber gloves prevent the direct contact of the consignee's finger with the signature capturing device and typically, the finger is required to contact the device in order to generate sufficient electrical coupling for the signature to appear on the device and to be saved electronically.

In addition, the use of writing implements may result in cross contamination between devices and the spread of infectious illness in laboratories, offices, schools and other populated environments. This cross contamination may have negative health consequences for the consignee, down line consignees, as well as the delivery personnel. Paper manifests also present certain inherent challenges, including the potential spread of disease and cross contamination.

There may be times when a recipient (consignee) who needs to provide an electronic signature is not present to receive a delivery. This may result in a delay of the delivery or perhaps the failure of delivery altogether. There may also be situations in which a parcel needs to be tracked. The tracking may be at the request of the receiver, supplier or shipper for record-keeping purposes.

Accordingly, there is a need for a system, method and device that allows a delivery person to track shipments, which may include delivery, without requiring the consignee to be present or to physically sign for receipt.

### BRIEF DESCRIPTION OF THE DRAWINGS

Preferred and alternative embodiments of the present invention are described in detail below with reference to the following drawings:

FIG. 1 is an illustration of system and device according to a preferred embodiment of the present invention;

FIG. 2 is a flow chart illustrating a method for generating an intelligent card suitable for use in the system and device of FIG. 1;

FIG. 3 is a flow chart of a method for using an intelligent card in the system and device of FIG. 1; and,

FIG. 4 is an illustration of an intelligent identification card including a QR code and personal identification information suitable for use with the system and device of FIG. 1.

### DETAILED DESCRIPTION OF THE PREFERRED EMBODIMENT

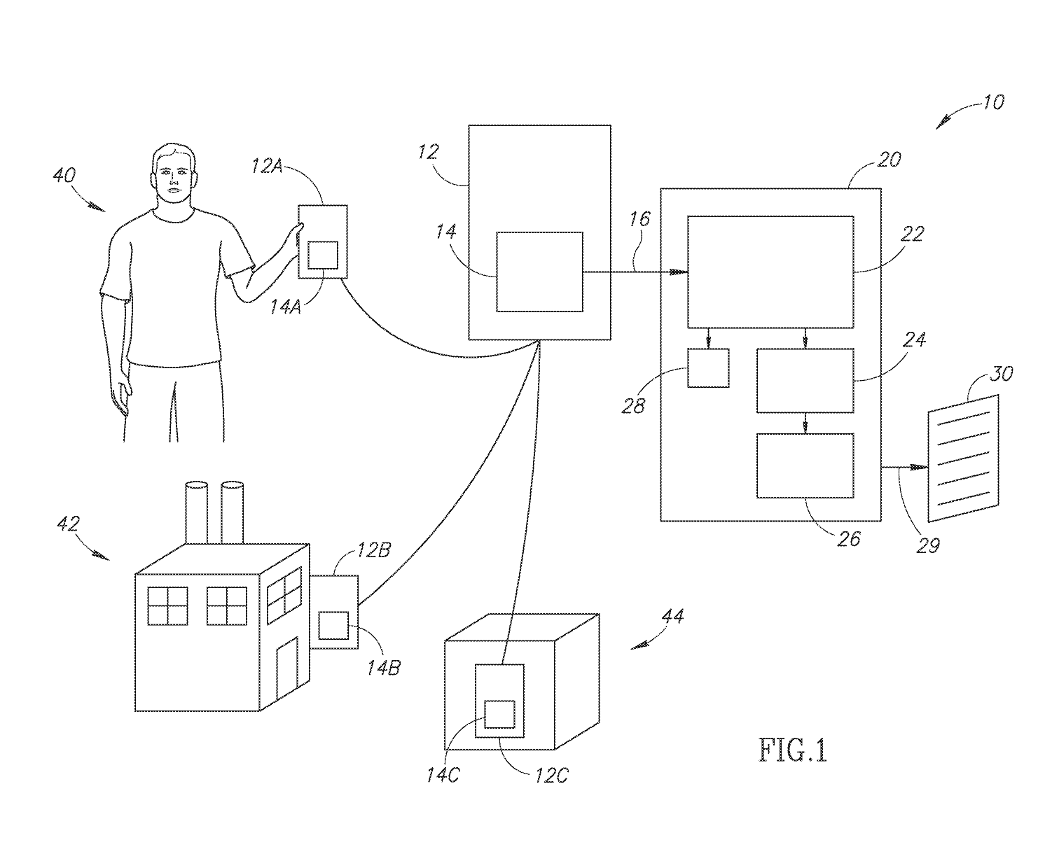

In accordance with a preferred embodiment of the present invention, and as illustrated FIG. 1, system 10 includes an intelligent card 12 preferably having disposed in or on it a bar code 14, such as a QR code, or other intelligence element that is capable of containing information that is machine readable, and reading device 20. Reading device 20 may, for example, be a smart phone, scanner or other device suitable for reading bar code 14 or other element containing machine-readable information. Device 20 preferably includes a viewing screen 22, bar code read module 24, memory module 26 and operator button 28. Operator 28 is intended for initiating the bar code reading process and may be a physical button (either hard or soft) or simply an auto start function that acts to initiate the barcode reading function when the reading device 20 detects a bar code 14.

When a delivery person arrives at the intended destination, she/he locates intelligent card 20 and reads the associated bar code 14 by aiming the view screen of device 20 at bar code 14. Information 16 (represented by the arrow line (16) in FIG. 1) contained in bar code 14 is read by device 20. Read module 24 interprets the information 16 and preferable stores it in memory module 26. If desired by the user or customer, a report 30 containing at least a portion 29 of the information 16 may be generated locally or remotely.

In accordance with a preferred embodiment of the present invention, an intelligent card 12, as discussed more fully below, is intended to aid shippers in the gathering of proof of delivery information, verification of unattended delivery completion, and tracking of shipping containers or packages. The card 12, which for example, may be in plastic or electronic form, preferably contains a bar code 14, such as for example, a QR code, that identifies a person, location, or container. The code 14 may be scanned by delivery personnel at various points during the transportation process to record vital information and create a permanent, verifiable record.

Illustrative examples of intelligent card 12 are further illustrated in FIG. 1 as an intelligent signature card 12A, intelligent delivery card 12B and intelligent tracking card 12C. It is understood these are merely examples of card 12 and do not represent an exclusive listing. In keeping with these examples, a consignee, or other person 40 authorized to receive a delivery, may possess a signature card 12A. In the manner generally set forth above, the delivery person uses her/his reading device 20 to read the bar code 14A on card 12A. Similarly, if a driver delivers a package to an unattended location, such as a building 42, she/he uses the device 20 to read bar code 14B on delivery card 12B, as a way to verify delivery to the proper location. Likewise, if the driver or delivery service desires to track the movement of a package 44, the driver may use the reader device 20 to read the bar code 14C on intelligent tracking card 12C located on the package 44 being shipped.

As briefly described above, intelligent signature card 12A card may aid a consignee 40 in proving his or her identity and to officially take possession of a shipment without having to physically sign a shipping document or electronic signature capture device. Consignees may be overburdened by the number of shipments they are required to receive and would benefit from using an intelligent signature card 12A to speed up the process of proving receipt of shipments. Other individuals may work in environments that have certain exposure risks that prevent them from using writing implements or electronic signature capture devices.

When the individual 40 needs to receive a delivery, she/he displays the card 12A to the delivery personnel who use mobile device 20 to scan the code 14A without touching the card 12A. Further, the consignee 40 need not touch the scanning device 20 or remove rubber gloves (if worn) in order to provide an electronic signature. The consignee's information is collected and saved verifying delivery and completion of a shipment.

The intelligent signature card 12A with QR code 14A helps to eliminate contamination of writing implements which is a priority for laboratories and many other environments such as office and school settings due to the desire to reduce the spread of infectious illness. The embedded QR code 14A preferably stores personally identifiable information that allows a consignee 40 to verify her/his identity when receiving a delivery. The intelligent signature card 12A may for example, be worn on a lanyard or clipped to one's clothing or attached to the consignee 40 in some other convenient manner so that the card 12A and QR code 14A permit the easy capture of electronic signatures without the need for direct contact of the consignee's finger with the signature capturing device or with a stylus, thereby reducing the risk of cross contamination and the spread of disease.

The intelligent delivery card 12B with QR code 14B may provide similar functionality for an unmanned delivery location such as a lock box, shelf location, or room. For example, when a delivery is made to an unattended location, in which a card 12B with a QR code 14B is located, the delivery person may simply scan the card to verify that the delivery person visited the unattended delivery location. Card 12B could be posted in any location, such as for example, on a wall near the entrance to a building, or on a surface near a receiving station. The delivery person scans the card 12B upon delivery to verify that she/he was at the proper location at the actual delivery time. The scanning event is preferably added to the permanent shipment record. In accordance with further embodiments, scanning the card 12B will preferably alert the delivery person if she/he attempts to deliver a shipment to the wrong location. In this way, the card 12B provides for proof of delivery to unattended delivery locations.

In yet another implementation of the present invention, intelligent card 12C is used in the manner illustrated and discussed above for tracking the location of a package during shipment. As depicted in FIG. 1, intelligent tracking card 12C is used to track the movement of a piece of equipment, shipping container or package 44. The card is attached to the equipment, container or package 44 and the driver scans the bar code 14C on card 12C at various points during the transportation process to record vital information and create a permanent, verifiable record.

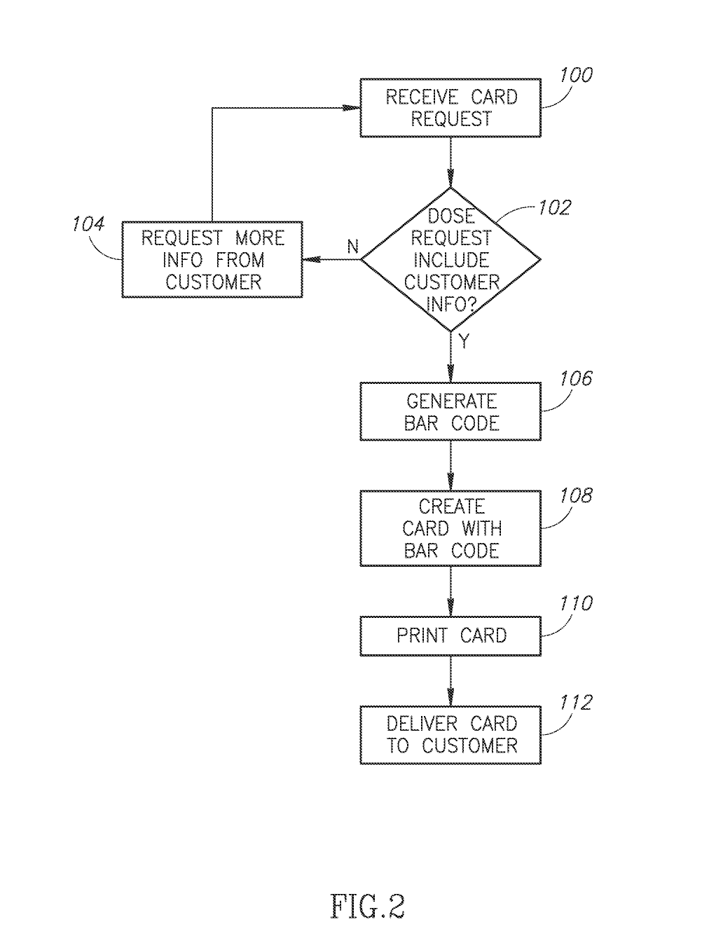

FIG. 2 illustrates steps in a method, according to a preferred embodiment of the invention, for creating an intelligent card and delivering it to a customer. Initially, a request for a card is received at step 110. If the request includes the desired customer information, “Yes” in step 102, then a bar code is generated at step 106. If there is inadequate information in the request, “No” at step 102, additional information may be requested from the customer in step 104. Once the bar code is generated 106, an intelligent card with the bar code is created at step 108, which may then be printed at step 110 and delivered to the customer at step 112.

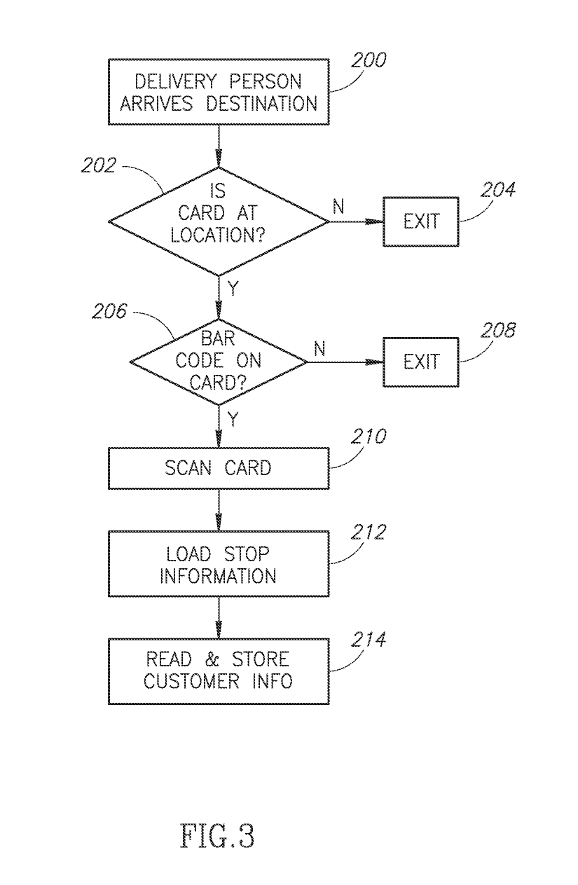

FIG. 3 illustrates steps in a method, according to a preferred embodiment of the invention, for using an intelligent card to track and record vital information related to the delivery of goods. When a delivery person arrives at a designated destination at step 200, she/he locates the appropriate intelligent card at step 202. If the card is not present (“No” at step 202), the delivery person may leave the premises without delivering the package at step 204. If the card is present (“Yes” at step 202), and if there is a bar code on the card (“Yes” at step 206), the delivery person scans the card at step 210. If there is no bar code (“No” at step 206), the delivery person does not scan the package at step 208. Once the card is scanned at step 210, the information from the barcode is loaded into the delivery person's bar code reader 20 (FIG. 1) at step 212. As noted above, reader 20 may be any device suitable for reading bar codes, such as, for example, a smart phone, a dedicated scanner or tablet loaded with an appropriate bar code reader application. Finally, the delivery person reads and stores the customer information at step 214. As noted previously and depicted in FIG. 1, the delivery person or service may generate a report 30 containing some or all of the information read at step 214.

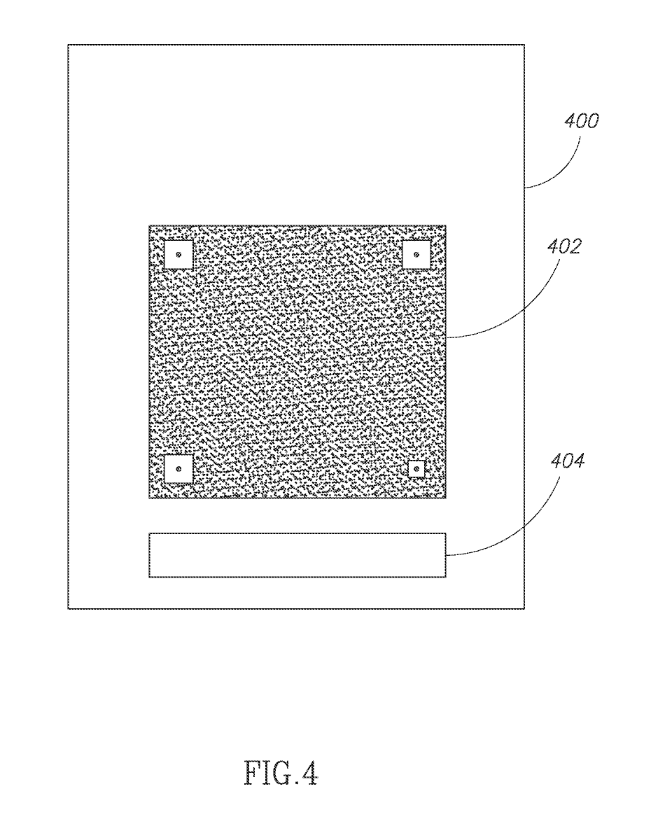

According to one embodiment of the present invention, and schematically illustrated in FIG. 4, a plastic intelligent card 400 preferably displays visibly the wearer's name (for signature card 12A), location information (for delivery card 12B), or package description or other identifying information (for tracking card 12C) as represented by information block 404 and further includes a bar code, such as a Quick Response (QR) code, or information storage element 402 containing personally identifiable information about the wearer, location or package, respectively.

While the preferred embodiment of the invention has been illustrated and described, as noted above, many changes can be made without departing from the spirit and scope of the invention. For example, information may be embedded in an identification card as a barcode other than a QR code or as another element containing machine readable information. Likewise, the identification card may be in any form factor and material, such as a flexible wrist band or non-wearable plaque mounted on a wall, for example. Accordingly, the scope of the invention is not limited by the disclosure of the preferred embodiment.

The embodiments of the invention in which an exclusive property or privilege is claimed are defined as follows:

1. A device for storing information that may be used to confirm an activity, comprising:
a support member having a first surface; and,
an information-containing element located on the first surface of the support member, wherein the information-containing contains information that may be retrieved by a reading device.

2. The device of claim 1, wherein the support member is a wearable identification card.

3. The device of claim 2, wherein the wearable identification card is made of plastic.

4. A system for retrieving information, comprising:
an information reading device;
a card having a first surface; and,
an information-containing element located on the first surface of the card, wherein the information reading device reads the information-containing element to retrieve information contained in the information-containing element.

5. The system of claim 4, wherein the information containing element is a bar code.

6. The system of claim 5, wherein the bar code is a quick response code.

7. The system of claim 4, wherein the information reading device is a smart phone.

8. A method for tracking and recording shipment of goods, comprising the steps of:
operating an information reading device;
aiming the information reading device at a barcode associated a good being tracked, wherein the barcode contains information related to at least one of tracking and shipment the good being tracked; and,
retrieving information contained in the barcode.
